(19) United States
(12) Patent Application Publication
(10) Pub. No.: US 2021/0284433 A1
(43) Pub. Date: Sep. 16, 2021

(54) Storage Assembly for Storing Active Substances

(71) Applicant: Flavour Message AG, Zug (CH)

(72) Inventors: Jörg Rychen, Zurich (CH); Hans Rudolf Gygax, Bad Ragaz (CH)

(21) Appl. No.: 16/332,471

(22) PCT Filed: Aug. 31, 2017
(86) PCT No.: PCT/EP2017/071896

§ 371 Date: Mar. 12, 2019

(30) Foreign Application Priority Data
Sep. 13, 2016 (CH) 01186/16

(51) Int. Cl. B65D 85/72; A23G 3/54; A23G 4/20; A23L 2/52; A23L 27/00

(52) U.S. Cl. CPC B65D 85/72; A23G 3/54; A23V 2002/00; A23L 2/52; A23L 27/72; A23G 4/20

(57) ABSTRACT

The present invention is directed to a storage assembly (1) for storing active substances (3) for producing an ingestible product (23). The storage assembly (1) comprises a plurality of storage elements (2), wherein the plurality of storage elements (2) is grouped into two or more groups of storage elements (2). For each group the storage elements (2) of the respective group have stored the same type of an active substance (3). At least one group includes at least two storage elements (2). For each one of the storage elements (2) of the plurality of storage elements (2) the storage element has stored one or more portions of an active substance (3), the portions containing the same amount of the active substance (3), defined as dose bit. For at least one group the dose bits of the storage elements (2) are defined in accordance to a dose pattern, which is designed such that the respective type of active substance (3) can be dosed over a given range and with a given precision for producing the ingestible product (23) by using one or more portions of the storage elements (2) of the respective group.

### FIELD OF THE INVENTION

The present invention relates to a storage assembly for storing active substances for producing an ingestible product. The present invention also relates to a production device and method for producing an ingestible product using the storage assembly.

### BACKGROUND OF THE INVENTION

An ingestible product may contain a plurality of substances. For example, an ingestible product may contain a plurality of flavoring substances to define its flavor. It is known that more than 1000 flavoring substances are active to the human olfactory and gustatory system. In order to provide ingestible products having e.g. a plurality of different flavors, a large variety of flavoring substances should be available. The doses of the flavoring substances required to generate an ingestible product can vary over several orders of magnitude. An ingestible product may also contain a plurality of vitamins and minerals which support the health of the body. Also a variety of extracts of plants may be contained in the ingestible product as well as stimulants like caffeine or any further active substances like colors or substrates or texture defining substances and so on. To generate an ingestible product one has often to blend a plurality of substances in defined doses. In many cases, during the blending process it is required to handle mass additions from grams down to nano-grams of substances per sample volume. Therefore, it is a challenging task to blend the substances in a precise manner for such a high dynamic range of the doses. To solve this problem, conventional solutions, such as the volumetric method, the gravimetric method and methods similar to inkjet or bubble jet methods are applied. Using the volumetric method, the substances are dosed with a precision syringe or pipette. In order to cover the high dynamic range of variation of the doses, several sized models of the syringe or pipette have to be used. Using the gravimetric method, the substances are dosed by weight, therefore, a mass balance which can precisely measure a weight variation in a large range is required. In methods similar to inkjet or bubble jet methods, single droplets of a substance are ejected onto a substrate. The dose is achieved by controlling the number of ejected droplets. High frequency ejection rate is needed to achieve a high dynamic range within a useful time.

WO16028029A1 relates to a scent spraying apparatus comprising a reception unit which can receive scent spraying information including at least one of a spraying amount and a spraying time from an external apparatus including at least one of a smartphone, a PC, and a server through wireless communication; a control unit which can receive the scent spraying information from the reception unit and generate and output a scent spraying control signal on the basis of the scent spraying information; and a scent spraying unit which can receive the scent spraying control signal from the control unit, and spray the scent on the basis of the scent spraying control signal. The scent spraying apparatus can receive a signal from an external apparatus used by another person so as to enable the scent to be sprayed, and thus, enables communication with the another person using a sense of smell.

### SUMMARY

It is an objective of this invention to provide a storage assembly for storing active substances for producing an ingestible product, which overcome at least some of the drawbacks known from the prior art. In particular, it is an objective of this invention to provide a cost efficient, precise and user friendly storage assembly for storing active substances for producing a user defined ingestible product. In particular, it is an objective of this invention to provide a storage assembly for storing active substances for producing an ingestible product which can store large varieties of active substances and can enable dosing of the active substances over a high dynamic range. In particular, it is an objective of this invention to provide a storage assembly for storing active substances for producing an ingestible product which enables the design of a production device for producing an ingestible product, wherein the production device is compact, low cost and user-friendly.

According to the present invention, these objectives are achieved through the features of the independent claims. In addition, further advantageous embodiments follow from the dependent claims and the description.

According to the invention, a storage assembly for storing active substances for producing an ingestible product comprises a plurality of storage elements, wherein the plurality of storage elements is grouped into two or more groups of storage elements. For each group the storage elements of the respective group have stored the same type of an active substance. At least one group includes at least two storage elements. For each one of the storage elements of the plurality of storage elements the storage element has stored one or more portions of an active substance, the portions containing the same amount of the active substance, defined as dose bit. For at least one group the dose bits of the storage elements are defined in accordance to a dose pattern, which is designed such that the respective type of active substance can be dosed over a given range and with a given precision for producing the ingestible product by using one or more portions of the storage elements of the respective group.

In some variants, for every type of active substance, there is a distinct dose pattern comprising as many dose bits as storage elements in the group of this type of active substance.

In some embodiments, the storage assembly is designed such that the ingestible product can be produced by using from each storage element of a subset of storage elements one portion.

Thus, the storage assembly enables the production of a user definable ingestible product by selecting a subset of the storage elements and taking from each selected storage element one portion containing a dose bit of active substance and blending all together.

The composition of an ingestible product is defined in a product formula, which describes the types of active substances to be chosen and the required dose of each chosen active substance.

The dose of the active substances required for a variety of user definable ingestible products may vary in different ranges. For example, the dose of active substance Sub1 may vary in the range of 1 milligram to 10 milligrams, whereas the dose of active substance Sub2 may vary in the range of 1 nanogram to 1 milligram. For each active substance a dose range is defined. The product formula may include any combination of active substances out of a defined catalog of active substances and for each chosen active substance a dose out of the defined range. This catalog of active substances and its dose ranges define the formula space, the set of all valid product formulas. Thus, each storage assembly defines a formula space spanning all product formulas that can be principally produced by using the respective storage assembly.

In some embodiments, the storage assembly includes at least 8 or at least 20 or at least 100 groups of storage elements. Each group represents a type of active substance, therefore the storage assembly includes at least 8 or at least 20 or at least 100 types of active substances.

In some embodiments, at least one group comprises more than 2 or more than 6 or more than 12 storage elements. Different groups of storage elements contain different types of the active substances. Within one group, each storage element contains the same type of active substance in a particular amount, defined as dose bit. Depending on the type of active substance and the formula space, the number of storage elements and the dose bits may vary.

In some embodiments, the dose bits of at least one group are defined in accordance to a dose pattern, which is based on one or more of: the binary system, the decimal system, the octal system, the hexadecimal system, a 1-2-5 system or a Fibonacci system.

A set of dose bits are defined in accordance to a dose pattern. For every type of active substance an individual dose pattern is defined. It is defined in a way that any dose out of the given range for this type of active substance can be approximated with a given precision by combining a subset of the dose bits of the dose pattern.

For example, the dose pattern comprises the dose bits of 1 milligram, 2 milligrams, 4 milligrams and 8 milligrams. A required dose of 12 milligrams may be obtained by combining the dose bits of 4 milligrams and 8 milligrams. If a dose of 10.1 milligrams is required, the dose may be approximately obtained by combining the dose bits of 2 milligrams and 8 milligrams.

An appropriate designed dose pattern allows to approximate the desired dose with a high precision, which is sufficient for generating the ingestible product. For example, if the ingestible product is a flavor product, the olfactory system of the human is addressed. As with other sensory organs of the human, the olfactory systems may detect the amount of an aromatic substance above a detection threshold value, which is the amount of this substance that is just detectable. Below the detection threshold value nothing is perceived at all. According to the Weber-Fechner law, for humans a relative increase of at least 10% of an amount of an aromatic substance is needed in order to generate a just noticeable difference. Therefore, it is enough accurate if a dose described in a flavor product formula can be approximated with a precision of about 10% by combining a subset of the dose bits.

The active substances are dosed and loaded into the storage elements in a factory, where sufficient facilities are available to dose the active substances very precisely even in very low amount. Therefore, the task of dosing an active substance in the field is simplified, because it is reduced to combining the amounts of the active substance in dose bits stored in the storage elements. Furthermore, the dosing is precise and reproducible since it is a discrete process. The storage assembly for active substances can be produced by machines featuring high throughput and/or high precision. The high precision of the pre-produced storage elements makes subsequent manufacturing of the actual ingestible product easier. No precision instruments are needed. It is sufficient to select the required storage elements of a storage assembly based on both, the dose patterns and the product formula defining the composition of the ingestible product and then blend one portion of the active substance stored in the selected storage elements. At the same time, a quite large number of different active substances in a large range of amount variation may be stored in the storage assembly to allow manufacturing a large number of different ingestible products.

In cases of flavoring substances, it has been shown that e.g. most flavors are composed of less than 30 types of flavoring substances out of a variety of about 300 types of flavoring substances. A storage assembly comprising e.g. 4000 storage elements, may provide e.g. 300 types of flavoring substances and for each the dose pattern comprises between 8 and 20 dose bits. This results in a solution which covers almost the entire human aroma space and is cost efficient, precise and easy to use. Furthermore, a flexible design may be achieved.

Depending on the formula space, the assemblies having different number of storage elements for example from 10 to several thousand may be provided. Moreover, the shape and the size of the assemblies may be adapted for different applications or for different formula spaces. In case of applying the assembly into a compact ingestible product manufacturing device, the maximal size of the assembly is in the range of several centimeters.

In the following, several dose patterns are disclosed. However, the dose patterns which may be applied for the storage assembly are not limited to these patterns described. It is important to design the appropriate dose pattern for each type of active substance based on the formula space that should be covered with the storage assembly such that the required dosages may be approximated with given precision. For each dose pattern, a basic dose D_{b} is defined. This basic dose D_{b} is preferably but not limited to the dose right at the detection threshold value of an active substance.

In one embodiment, the dose pattern is based on the binary system. The dose bits having the following values based on the binary system may be comprised in the dose pattern: the basic dose D_{b}; 2 times the basic dose D_{b}; 4 times the basic dose D_{b} . . . and 2ⁿ⁻¹ times dose D_{b}. For example, the dose pattern A comprises the dose bits A1, A2, A3, . . . An. The dose bit A1 is the basic dose D_{b}, the dose bit A2 is 2 times basic dose D_{b}, the dose bit A3 is 4 times basic dose D_{b} and the dose bit An is therefore 2ⁿ⁻¹ times of dose D_{b}. It can be seen, that this pattern provides a large range of amount variation, namely from 0 to (2ⁿ−1) times D_{b} in steps of D_{b}. If the dose pattern comprises 20 dose units, a variation range over more than a million may be achieved.

In another embodiment, the dose pattern is based on a 1-2-5 system. The dose bits having the following values are comprised in the dose pattern: the basic dose D_{b}; 2 times of the basic dose D_{b}; 5 times of the basic dose D_{b}. For example, the dose pattern A comprises the dose bits A1, A2, A3, . . . A8. The dose bit A1 is the basic dose D_{b}, the dose bits A2 and A3 are 2 times of basic dose D_{b}, the dose bit A4 is 5 times of basic dose D_{b}, the dose bit A5 is 10 times of basic dose D_{b}, the dose bits A6 and A7 are 20 times of basic dose D_{b} and the dose bit A8 is 50 times of dose D_{b}.

In another embodiment, the dose pattern is based on a Fibonacci system. The dose bits having the values based on the Fibonacci numbers may be comprised in the dose pattern. For example, the dose pattern A comprises the dose bits A1, A2, A3, . . . An. The dose bits A1 and A2 are the basic dose D_{b}, the dose bit A3 is 2 times of basic dose D_{b}, the dose bit A4 is 3 times of basic dose D_{b}, the dose bit A5 is 5 times of basic dose D_{b}, the dose bit A6 and A7 are 8 and 13 times of basic dose D_{b}, respectively. This pattern provides more flexibility of selecting the storage elements, because several different combinations of dose bits can be chosen to approximate a required dose. This enables to optimize and balance the consumption from the different storage elements. Also, by adjusting the number of selected dose bits, the weight or size of the ingestible product can be controlled. Furthermore, the selection pattern can be randomized to help obscure the formula.

In some embodiments, the active substances are designed for producing an ingestible product that is one or more of: a flavoring product, a confectionary product, a food product, a pytologic product, a stimulant or a beverage. In particular, the food product may be a functional food.

Most ingestible products contain not only the active substances but also a large extent of a substrate, such as for example sugar, water, oil, gum or paper. The substrate may be added into after or during blending the active substances released from the storage elements.

In one embodiment, the ingestible product has a size of a mouthful. The ingestible product in this size has a weight for example in the range of 0.1 g to 5 g. This can be for example a candy or chewing gum with sugar or gum as substrate respectively and containing the active substances according to a user defined formula.

In another embodiment, the ingestible product can be in the form of a tea. The active substances stored in the storage assembly are in this embodiment dried parts of plants and mushrooms and further natural substances. To form the final product, the selected active substances have to be extracted in hot water which forms the substrate.

In further embodiments the ingestible product is a condiment used for cooking, or a syrup for flavoring a drink. In this case the substrate can be an oil or a glycose syrup or water.

The active substances maybe aroma substances, taste substances, flavoring substances, colors, vitamins, minerals, drugs, stimulants, plant extracts, sugars, fats, proteins or any other substances suitable for a product intended for human ingestion.

In some embodiments, the active substance is stored in one or more of the following forms: in a solid form such as a pill or a globule, in a fluid form, in the form of a gel, in the form of a paste, in the form of a gum, or in the form of a powder.

In some embodiments, the active substance contained in the storage element is mixed in a substrate. In a variant, the storage element is formed by a substrate material containing the active substance, for example, in the case of storage elements having a form of a globule made from sugar. In another variant the active substance is encapsulated in a substrate material for example in a gum or gelatin sphere.

Even when the substrate material is also an active substance as for example in the case of sugar which is sweet, there is only one substance regarded as the active substance in a storage element.

Additionally, the storage assembly may contain a plurality of substrate storage elements which only contain substrate material.

In some embodiments, the storage elements have one or more of the following forms: cavities, globules, microcapsules, pills, reservoirs, and coated carriers.

In one embodiment, it is favorable to have a storage assembly having a blister packaging comprising a plurality of cavities. Each cavity forms a storage element, in which the active substance can be stored.

In a further embodiment, the storage element is in a form of a globule, which contains the active substance with or without substrates. A plurality of globules as storage elements can be loosely packaged in a container, such as a bowl.

In an embodiment, the storage element is in a form of a reservoir. This is in particular favorable, if the active substance is in a fluid form.

In another embodiment, a pinch of microcapsules forms a storage element to store the active substance. The storage assembly may have the form of an ingestible product such as a candy or a chewing gum containing different types of microcapsules.

In some embodiments, the storage elements are arranged in accordance to one or more of: a three-dimensional lattice, a two-dimensional array or lattice, a one-dimensional array, a chain along a line or wire, an array along a curve, and a loose or rigid grouping in a container such as a bowl.

The storage elements may also be dispersed over the storage assembly as it is for example, the case for microcapsules. Logically, the storage assembly may be designed having different shapes, such as square, or round-like, or cubic and so on. Different shapes of the storage assembly may be used for different types of storage assemblies which cover different formula spaces. For example, a storage assembly can have the form of an apple if its formula space allows for a variety of different apple flavors.

In some embodiments, the storage elements are arranged in the storage assembly in a manner that the storage elements may be discharged simultaneously. The production speed may be improved. In these embodiments, the storage elements may be arranged in a form of having a defined position on the storage assembly. One variant of the arrangement is a two-dimensional lattice. Also the embodiment, in which the storage elements have the forms of microcapsules, allows to activate the storage elements simultaneously.

In some embodiments, one or more storage elements are arranged in a manner that the storage elements may be discharged in series. This requires a simpler packaging. For example, in the case that the storage element has a form of a globule, the storage elements can be packaged all together such as in a container or a tube.

In some embodiments, the storage elements are designed such that identification of the dose bit and/or type of the active substance stored in the storage elements is enabled by an element property of the storage element and an assignment information of the storage assembly.

The assignment information allows to assign to each element property the type of active substance and/or the dose bit or concentration of active substance stored within each storage element.

In one embodiment the assignment information can be retrieved from for example a look-up table in which each row describes the element property of the storage element, the type and the dose bit of the active substance stored in this storage element. In a preferred variant, the number of the rows of the table corresponds to the number of the storage elements.

The assignment can be the same for all exemplars of one type of storage assembly or it can differ among the individual exemplars of the storage assembly.

In some embodiments, the element property of a storage element is related to one or more of: the location of the storage element in the storage assembly, an externally readable code such as a pattern or color, a geometry of the storage element, an electromagnetic property of the storage element, or any other physical, mechanical or chemical property of the storage element or combinations thereof.

For determining the dose bit and/or type of active substances stored in each storage element, the position of the storage element within the assembly can be chosen as an element property. In particular, if the storage elements are arranged in a two-dimensional array or one-dimensional array. In a corresponding assignment information, for example in the form of look-up table allocated to this assembly, the position of each storage element, the does bit and the type of the active substance contained in each storage element are defined.

If the storage elements are arranged within the assembly in a manner without fixed position, the storage elements may be marked with externally readable properties such as codes, patterns, colors, or numbers. For example, in embodiments wherein the storage element has a form of a globule and all storage elements are stored loosely in a container. In addition, other properties of the storage element such as the geometry, an electromagnetic property, or any other physical, mechanical or chemical property may be chosen as the element property.

In one embodiment, the storage elements are designed such that the storage elements may be selectively activated based on an activation property of the storage elements.

The activation property may be a wavelength of an electromagnetic wave. By applying electromagnetic waves of different wavelengths, the corresponding storage elements are activated such that the active substances contained in the respective storage elements are discharged. In this case the assignment information relates the wavelength for activating a storage element to the dose bit and type of active substance. This is particular favorable for the embodiment, in which the storage elements have the form of microcapsules.

In some embodiments, the storage assembly includes an assembly property which allows to retrieve the assignment information of the storage assembly. The assignment information may be contained in the storage assembly or delivered with it.

The assembly property is e.g. an identification code, a text or a graphic symbol arranged on the storage assembly. In addition, other properties of the storage assembly such as a shape or color of the storage assembly, RFID or mechanical markers may also be chosen as the assembly property.

In some embodiments, the assignment information is kept secret from the end user.

In one embodiment, a plurality of storage assemblies is designed such that each storage assembly has an individual assignment.

In an embodiment, a production device for producing an ingestible product is configured to select a subset of the storage elements and to discharge from each selected storage elements a portion of the active substance and combine the discharged active substances to form the ingestible product.

In one embodiment, the production device comprises an additional substrate such as sugar, water, oil for producing the ingestible product.

In one embodiment, the production device comprises discharging means enabling discharging of portions of the active substances from the storage elements.

In one embodiment, the production device is configured to receive data defining the storage elements to be selected and to discharge the portions of the active substances from the selected storage elements.

The production device may comprise a processing unit and an operating unit. The processing unit controls the operating unit to discharge the selected storage elements. The discharged active substances may be blended together with or without additional substrates to manufacture the ingestible product. By applying the storage assembly disclosed in the present invention, the complexity of the device for producing the ingestible products can be reduced dramatically, because the process of dosing the active substances can be simplified. Therefore, the device can be implemented in a small size with low costs. It may be a hand-held device.

In a further embodiment, the active substances are dischargeable from the storage elements by one or more of the following means: mechanically, optically, chemically, electrically and thermally.

In one variant, the production device is configured to mechanically discharge the active substances stored in the storage elements, such as pressing, stamping, cutting, or drilling or scratching.

In some embodiments, the production device is configured to discharge active substances stored in one or more storage elements comprised in a storage assembly simultaneously or in series.

In some embodiments, the production device is configured such that a bit pattern can be applied. Each element of the bit pattern defines if a predefined portion of the active substance stored in the respective storage element is required for producing the ingestible product.

In an embodiment, a method for producing an ingestible product comprises: selecting a subset of storage elements and discharging from each of the selected storage elements a portion of the active substance and combining the discharged active substances to form the ingestible product.

### BRIEF DESCRIPTION OF THE DRAWINGS

In order to describe the manner in which advantages and features of the disclosure can be obtained, in the following a more particular description of the principles briefly described above will be rendered by reference to specific embodiments thereof which are illustrated in the appended drawings. These drawings depict only exemplary embodiments of the disclosure and are not therefore to be considered to be limiting of its scope. The principles of the disclosure are described and explained with additional specificity and detail through the use of the accompanying drawings in which:

FIG. 1 illustrates a schematic of an embodiment of a storage assembly where the storage elements are arranged in a two-dimensional array;

FIG. 2 illustrates a schematic of the cross section of a blister packaging of an embodiment of the storage assembly with two-dimensional arrangement of the storage elements;

FIG. 3 illustrates assignment information in form of a look-up table of an embodiment of the storage assembly with the position of the storage elements as an element property;

FIG. 4 illustrates an embodiment of the storage assembly integrated into a bottle cap to generate flavored beverages;

FIG. 5 illustrates an embodiment of the storage assembly wherein the storage elements are globules contained loosely in a bowl;

FIG. 6 illustrates an embodiment of the storage assembly wherein the storage elements are globules arranged as one-dimensional array within a tube;

FIG. 7 illustrates an embodiment of the storage assembly wherein the storage elements are reservoirs each containing a plurality of globules of the same type;

FIG. 8 illustrates an embodiment of the storage assembly wherein the storage elements are reservoirs containing the active substance in a liquid form;

FIG. 9 illustrates a further embodiment of the storage assembly wherein the storage elements are reservoirs;

FIG. 10 illustrates an embodiment of the storage assembly wherein the storage elements are formed by microcapsules;

FIG. 11 illustrates a dose pattern comprising dose bits based on the binary system;

FIG. 12 illustrates a dose pattern comprising dose bits based on the decimal system;

FIG. 13 illustrates a dose pattern comprising dose bits based on a 1-2-5 system;

FIG. 14 illustrates a dose pattern comprising dose bits based on a Fibonacci system;

FIG. 15 illustrates a block diagram of a production device for producing an ingestible product comprising a storage assembly (before the production).

FIG. 16 illustrates a block diagram of the production device for producing an ingestible product comprising a storage assembly (after the production).

### DESCRIPTION

FIG. 1 shows a schematic of one embodiment of a storage assembly 1 for storing active substances 3 for producing an ingestible product. The storage assembly comprises a plurality of groups of storage elements. The storage elements 2 of different groups have stored a different type of active substance 3. The storage elements of the same groups have stored the same type of active substance. In this embodiment, the storage elements 2 are arranged in a two-dimensional array. The signs “-”, “!”, “)”, “*”, “}” and “]” illustrate different types of active substances 3 and the number of signs illustrate the amount of the respective type of active substance stored. As illustrated in FIG. 1, the storage elements of the first group 30 have stored the active substances symbolized with the sign“-”, the storage elements of the second group 31 have stored the active substances symbolized with the sign “!” and the storage elements of the third group 32 have stored the active substances symbolized with the sign T. The storage elements of the same group have stored the same type of active substance. For example, the storage elements of the first group 30 have stored the active substance symbolized with the sign “-”. In this embodiment, each storage element of a group contains one portion of the same type of an active substance and the amount of the one portion of the active substance is defined as a dose bit. For example, the storage elements 30a, 30b and 30c in the group 30 contain the active substance sub 1, the amount of one portion of the active substance sub 1 stored in storage element 30a is dose bit 1, the amount of one portion of the active substance sub 1 stored in storage element 30b is dose bit 2 and the amount of one portion of the active substance sub 1 stored in storage element 30c is dose bit 3. The dose bit 1, dose 2 and dose bit 3 are defined in accordance to a dose pattern. Depending on the type of the active substance and the formula space to be spanned by the storage assembly, an appropriate dose pattern can be chosen.

In this embodiment, each storage element 2 contains only one portion. Therefore, the ingestible product can be produced by using the entire content of active substances 3 stored in a subset of the storage elements 2.

The number of the storage elements may vary in a wide range up to several thousand depending on the applications. In such embodiments, the storage assembly 1 can comprise 4096 storage elements arranged in an array of 64×64. Arranging a high number of storage elements 2 provides a versatile application of the storage assembly 1. For example, in the application that the assembly is applied for producing a flavoring product, a plurality of flavoring substances can be stored in the storage elements 2, such that most flavors can be realized by using this assembly 1. Each storage element 2 contains an active substance 3 in an amount of a dose bit defined in a dose pattern. In the 4096 storage elements, more than 300 active substances may be stored and for each active substance a dose pattern comprising between 8 and up to 20 dose bits may be employed. Some storage elements 2 contain the active substances 3 mixed with a substrate, which may be e.g. sugar or water or gum. The assembly 1 may further comprise a plurality of substrate storage elements 4, which contain only a substrate material such that a defined weight or size of an ingestible product may be achieved by adding the substrate material.

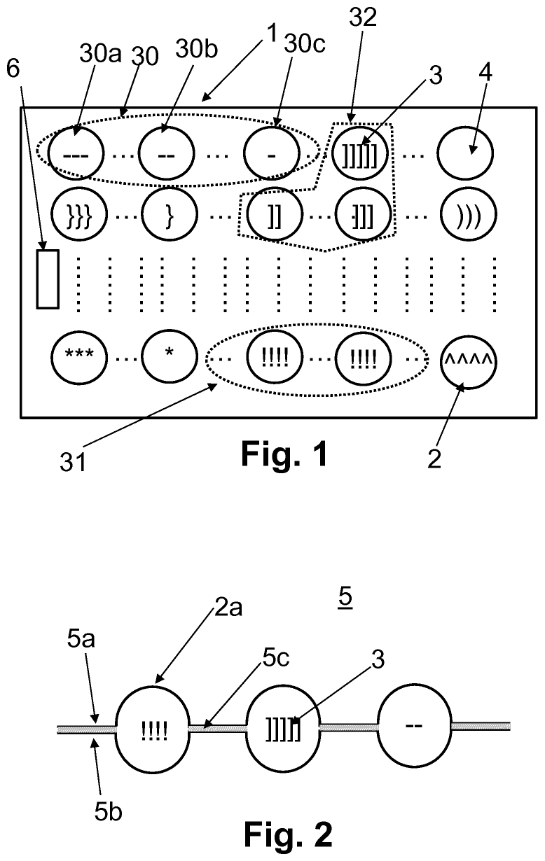

FIG. 2 illustrates one particular variant of the storage assembly in a form of a blister packaging 5. The active substances 3 are enclosed in cavities 2a formed between a top sheet 5a and a bottom sheet 5b. The top sheet 5a and the bottom sheet 5b may be made of paper, plastic, metal or other suitable material. The cavities 2a as the storage elements are separated by the glued part 5c and the active substances 3 are enclosed in the cavities 2. The active substances 3 are stored with or without a substrate in a solid form such as a pill or in a liquid form or in form of gel or powder. The blister packaging 5 can be used for a storage assembly shown in FIG. 1. The size and the weight of the storage assembly 1 comprising 4096 storage elements are in the range of several centimeter and several grams, respectively.

As shown in FIG. 1, an assembly property 6 is included on the storage assembly 1. FIG. 1 illustrates the variant, that the assembly property 6 is an externally readable code. After reading the assembly property 6, the assignment information associated to this storage assembly can be retrieved. The assignment information allows to determine the subset of the storage elements to be selected for producing the requested ingestible product.

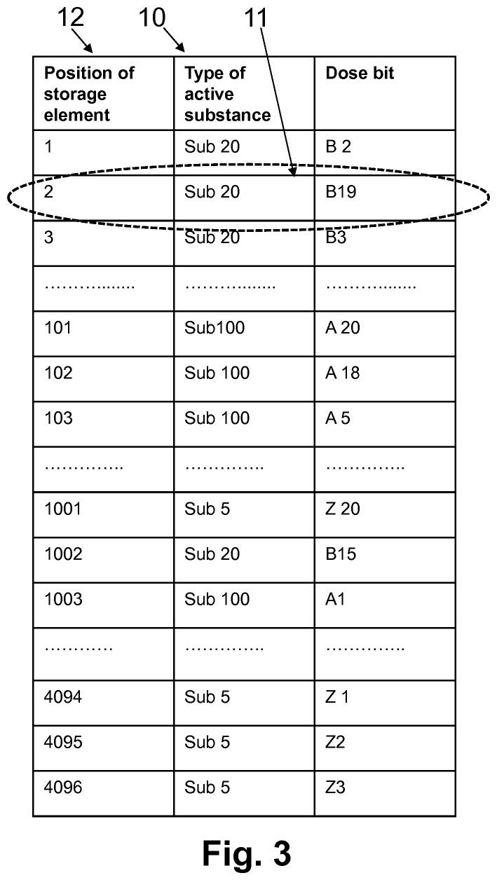

FIG. 3 illustrates one variant of storing an assignment information 10 allocated to a storage assembly 1, such as in form of a look-up table. The assignment information includes 4096 data elements 11 corresponding to the 4096 storage elements. Each data element 11 describes the element property 12 of the storage element, the does bit and the type of the active substance stored in this storage element.

FIG. 3 depicts one example of using the position of the storage element as the element property 12. In particular, for the assembly arranged in an array shown in FIG. 1. By accessing the assignment information, the information about the type of the active substance 10 stored in each storage element and the dose bit of each storage element is gained. For example, the storage element at the position (1) comprises the active substance sub 20 in a dose bit B2 and the storage element at the position (4096) comprises the active substance sub 5 in a dose bit Z3. If other properties such as e.g. the color or the geometry of the storage element are chosen as the element property, the data element 11 includes the corresponding properties instead of the position.

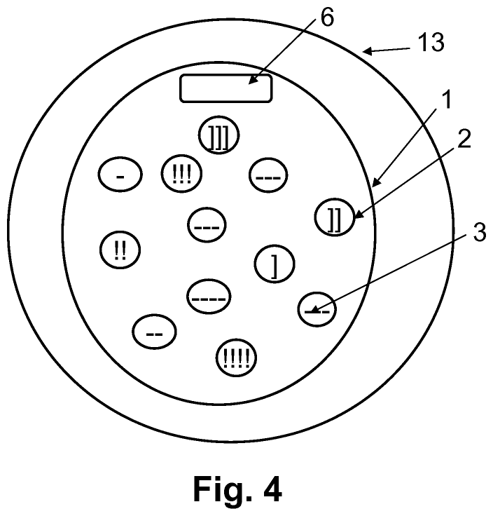

FIG. 4 illustrates a cap 13 of a beverage container, in which the storage assembly 1 is embedded. The storage elements may be small cavities which contain the active substance as liquid, powder or in a solid water-soluble form. In order to produce a beverage, a subset of storage elements 2 is selected and opened to release the active substances 3 contained in the selected storage elements into the beverage. After a shake of the bottle, the beverage can be consumed.

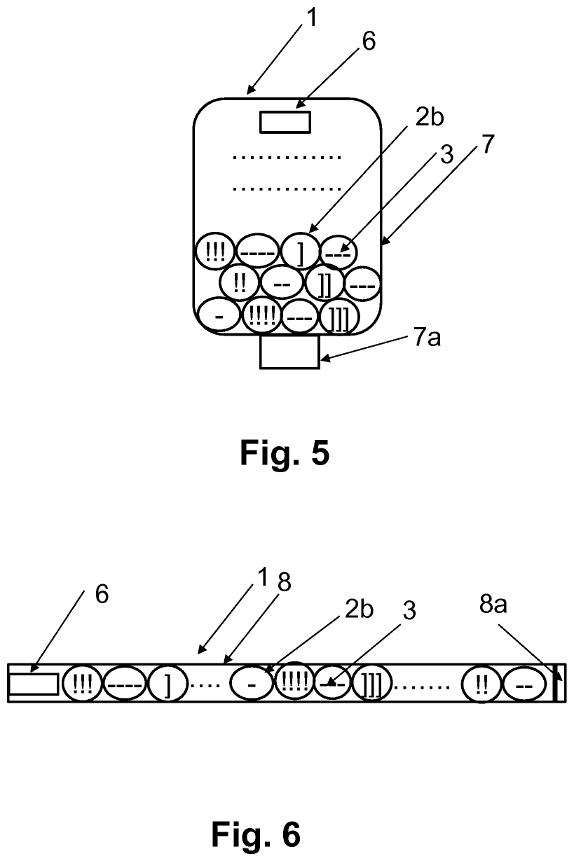

FIG. 5 illustrates another embodiment of a storage assembly 1. In this embodiment, the storage element has the form of a globule 2b, namely a small sphere of e.g. 0.5 mm diameter, and contains the active substance mixed with or without the substrate, which is e.g. sugar. In a particular variant, about 4096 globules 2b are stored loosely in a container 7 having a nozzle 7a to allow the globules to be dropped one by one from the bowl. An externally readable assembly property 6 is arranged on the container which allows to retrieve the assignment information for each individual storage assembly. In this embodiment, an element property may be advantageously an externally detectable property such as for example a code, a pattern or a spectroscopic property, so that the globule 2b can be identified. Using the element property and the assignment information allows to determine the type and dose bit of active substances stored in each globule 2b. Each element of the assignment information includes e.g. the code, the pattern or the spectroscopic property of each globule 2b and the type and the dose bit of the active substance contained in each globule 2b.

FIG. 6 illustrates one embodiment of a storage assembly 1, in which the arrangement of the storage elements is in accordance to a one-dimensional array.

In this embodiment, about 4000 storage elements in form of the globules 2b are arranged in a tubular container such that they cannot swap positions. The globules can be discharged at one end of the tube one by one by opening a closure 8a arranged at one end of the tube. For this embodiment, the element property may be the position of the globules 2b in the linear chain of globules. The tubular container 8 is not limited to have a straight shape.

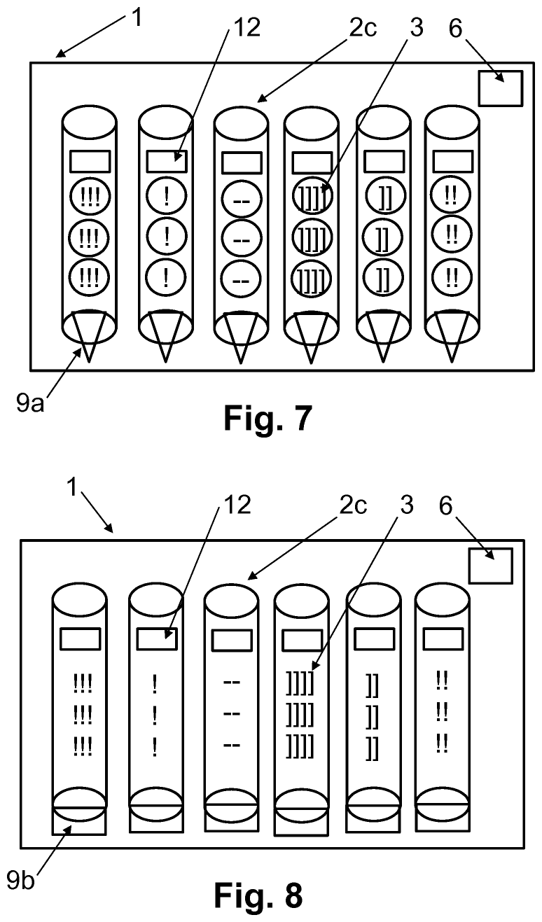

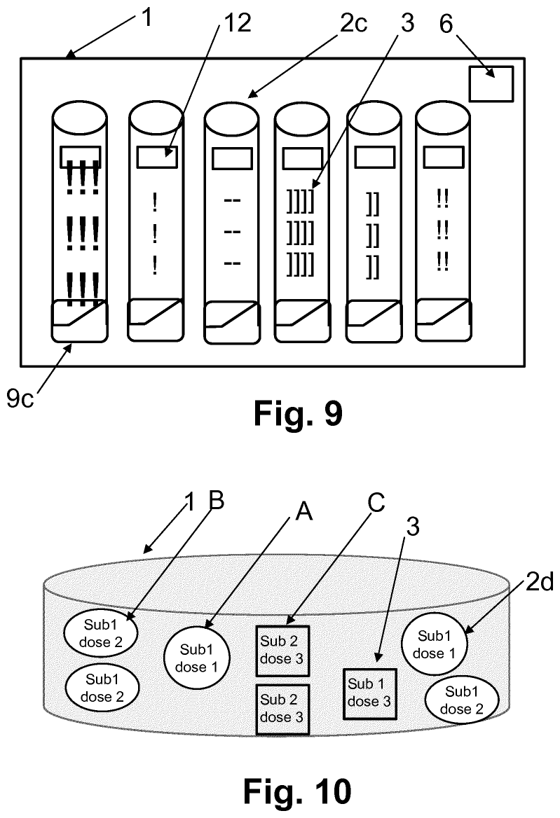

FIG. 7, FIG. 8 and FIG. 9 illustrate three embodiments of a storage assembly 1, in which the storage element is in a form of a reservoir 2c. The reservoirs 2c as storage elements may be arranged in a two-dimensional array or one-dimensional array depending on the number of storage elements required. A stable holding means is required to hold all the storage elements.

FIG. 7 shows a variant of a storage assembly 1 wherein the active substance 3 mixed with or without a substrate is provided in portions of a solid form such as a small pill. In each reservoir 2c, a plurality of portions of active substances are stored. Each of the portions of one storage element have the same amount of active substance, which is defined as a dose bit. FIG. 7 shows one embodiment, that each storage element includes three portions of active substances. Each reservoir 2c includes a flap 9a for discharging a single portion of the active substance in the form of a single pill containing one dose bit of active substance. In this embodiment, the element property 12 may be the position of the reservoir within the assembly as illustrated in FIG. 3 or an externally readable code, a pattern or a color marked on or near the reservoir.

The variant of the storage assembly shown in FIG. 7 allows to produce multiple different ingestible products.

FIG. 8 illustrates another variant of a storage assembly 1, in which the active substance is stored in a fluid form. The active substance may be mixed with a substrate fluid (diluted) or pure. The storage element includes a discharging means 9b which discharges a fixed portion of the fluid contained in the storage element when activated (e.g. a single drop dispenser). For each storage element in the assembly the concentration of the active substance in the fluid is configured such that a discharged portion contains the amount of active substance of the dose bit associated with this storage element. To produce an ingestible product a subset of storage elements is selected and for each selected storage element the discharging means 9b is activated to release a portion. The released portions collectively form the requested ingestible product, either with or without additional substrate material. With this variant of storage assembly multiple different ingestible products can be produces.

FIG. 9 illustrates a variant of a storage assembly 1, in which a continuous flow of an ingestible product can be produced. The active substances are stored in a fluid form. The active substances may be mixed with a substrate fluid (diluted) or pure. The doses in the formula are interpreted as the amount of active substance per time unit. And the dose bits associated to the storage elements are thus also interpreted as an amount of active substance per time unit. Each reservoir as the storage element comprises a valve 9c as the discharging means. It has only two states: open and closed. When activated it releases a defined constant flow (one defined portion per time unit) of material from the reservoir containing the active substance in amounts specified by the dose bit associated to the storage element. The storage elements may be pressurized to enable a constant flowrate. This variant of storage assembly is useful for a 3D food printer. In such an application the deposited material can be varied in quality according to different formulas which results in different selection pattern for the storage elements applied.

FIG. 10 illustrates a further embodiment of a storage assembly 1. In this embodiment, the storage element is formed by a pinch of microcapsules 2d containing the active substance. The storage assembly may have the form of an ingestible product such as a candy or a chewing gum. A plurality of different types of microcapsules are included in the storage assembly. Every type of microcapsules forms a separate storage element containing one portion of the active substance. The amount of active substance contained in a storage element is the dose bit and is given by the number of microcapsules of this type and the amount of active substance in each microcapsule of this type.

In order to produce an ingestible product, a subset of all the types of microcapsules may be activated by e.g. an electromagnetic wave to release the active substances contained therein. The frequency of the electromagnetic wave being specific for each storage element. This has the advantage that no waste is generated: the unopened capsules are ingested as well but keep the substance enclosed. Also, the process of production of the ingestible product is simplified since after selection and activation of the storage elements the product is ready for consumption, the substances being homogeneously distributed.

In FIG. 10, different types of microcapsules A, B, C are illustrated in the round shape, oval shape and square shape, respectively. For example, the type A includes the active substance Sub 1 in dose bit 1, the type B includes the same type of active substance Sub 1 but in dose bit 2 and the type C includes a different type of active substance Sub 2 in dose bit 3. All the microcapsules having the round or oval shape, namely type A and B are grouped in one group, because they contain the same type of active substances Sub 1. The microcapsules of type C is grouped to another group, because they contain another type of active substance Sub 2.

Each storage element may be individually activated by an electromagnetic wave having a particular wavelength. In this embodiment, an element property may be advantageously a wavelength of the electromagnetic wave. Therefore, the assignment information allocated to this assembly, relates instead of a position of a storage element as shown in FIG. 3, a wavelength of an electromagnetic wave to the active substance and dose bit contained in a storage element.

To produce the requested ingestible product, a subset of the storage elements are selected by applying electromagnetic waves having the selected wavelengths, the corresponding microcapsules included in the candy are activated and the active substances stored are released from the activated microcapsules.

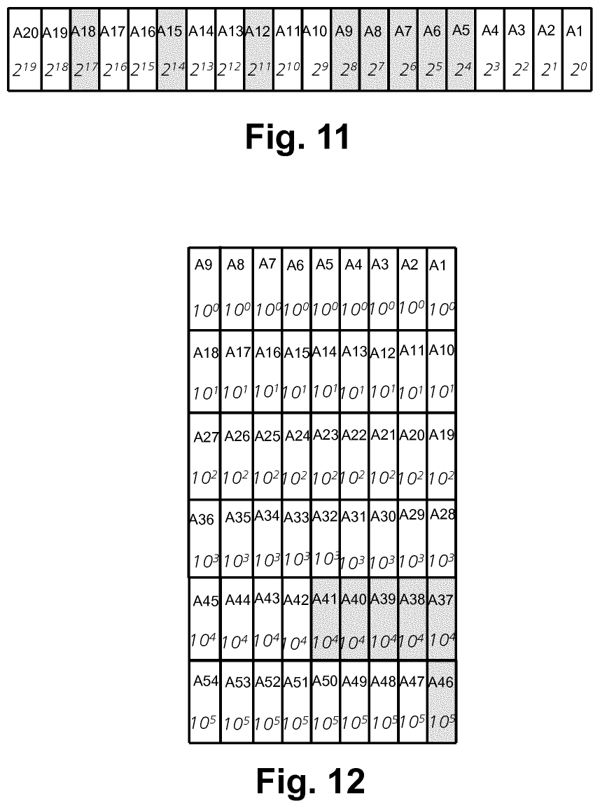

FIG. 11 illustrates a dose pattern A based on the binary system. The pattern A comprises for example 20 dose bits A1 to A20. The dose bit A1 is a basic dose D_{b}, which may be the detection threshold value of an active substance. The dose bit A2 is two times of the basic dose and the dose bits A3, A4, A5 are 4, 8, 16 times of the basic dose, respectively. Consequently, the dose bit A20 has 2¹⁹ times of the basic dose. If a dose of 150,000 times of basic dose is required, the dose bits A18, A15, A12, A19, A8, A7, A6 and A5 may be combined, because the sum of them is 150000 times of basic dose.

FIG. 12 illustrates a dose pattern A based on the decimal system. The pattern A comprises for example 54 dose bits A1 to A54. The dose bit A1 is a basic dose D_{b}, which may be the detection threshold value of an active substance. The dose bit A10 is ten times of the basic dose and the dose bits A19, A28, A37 and A46 are 100, 1000, 10000 and 100000 times of the basic dose, respectively. In particular, several dose bits have the equal value, such as A1 to A9 and A10 to A18. If a dose of 150000 times of basic dose is required, the dose bits A37, A38, A39, A40, A41, and A46 may be combined, because the sum of them is 150000 times of the basic dose.

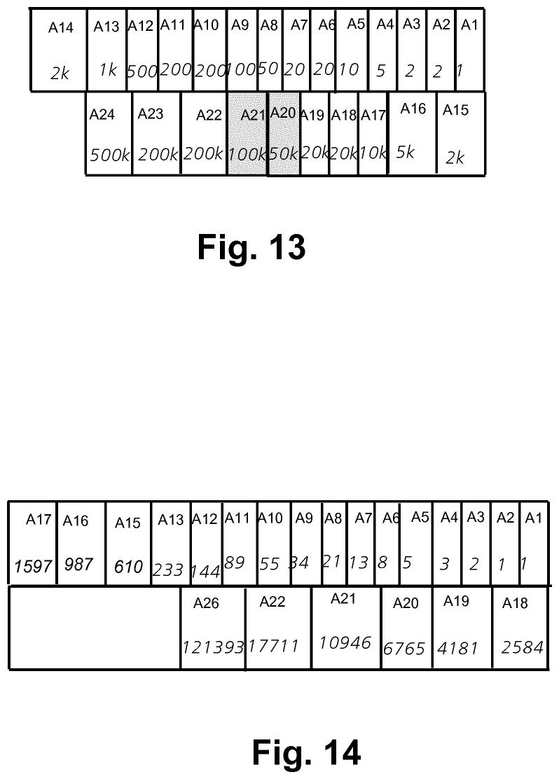

FIG. 13 illustrates a dose pattern A based on the 1-2-5 system. The pattern A comprises for example 24 dose bits A1 to A 24. The dose bit A1 is a basic dose D_{b}, which may be the detection threshold value of an active substance. The dose bits A2 and A3 are two times of the basic dose and the dose bits A3 is 5 times of the basic dose, A5 is 10 times of the basic dose, A6 and A7 are 20 times of the basic dose. If a dose of 150000 times of the basic dose is required, the dose bits A20, and A19 may be combined, because the sum of them gives the value of 150000 times of basic dose.

FIG. 14 illustrates a dose pattern A based on a Fibonacci system. The pattern A comprises for example 26 dose bits A1 to A26. The dose bit A1 and A2 are basic dose D_{b}, which may be the detection threshold value of an active substance. The dose bits A3 is two times of the basic dose and the dose bits A4 is 3 times of the basic dose, A5 is 8 times of the basic dose. The values of the subsequent dose bits are based on the Fibonacci numbers. This pattern allows a more balanced usage of the storage elements. For example, a dose of 15000 times of the basic dose is required, at least following two combinations of dose bits may fulfill this requirement: combining dose bits A5, A9, A12, A14, A16, A18, A20, A22 and A26; or combining dose units A5, A9, A10, A11, A12, A13, A14, A15, A16, A17, A18, A19, A20, A21 and A26.

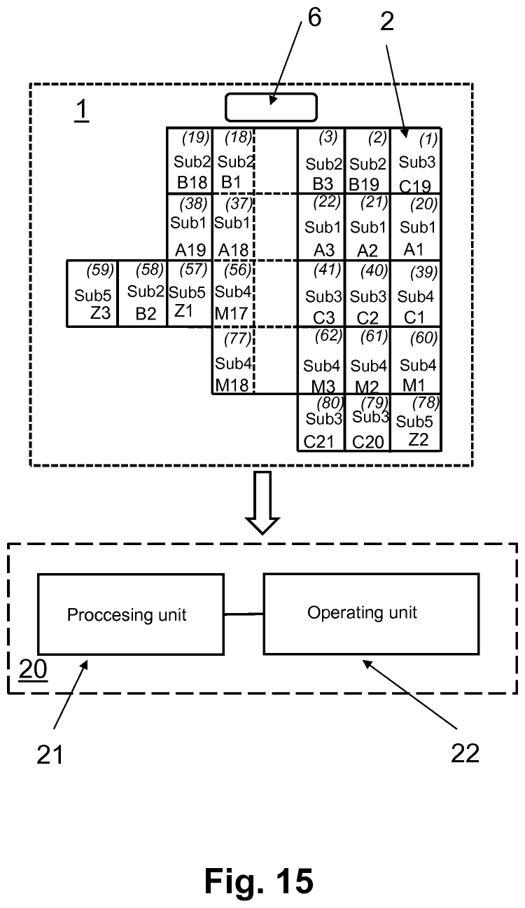

FIG. 15 illustrates a block diagram of a production device 20 for producing an ingestible product comprising a storage assembly disclosed in the present invention. The device comprises an operating unit 22 and a processing unit 21 connected to the operating unit. The operating unit is configured to select a subset of the storage elements and to discharge from each selected storage element one portion of the stored active substance and combine the discharged active substances to form the ingestible product. The processing unit 21 is configured to receive data defining the storage elements to be selected and control the operating unit 22 to discharge the portions of the active substances from the selected storage element.

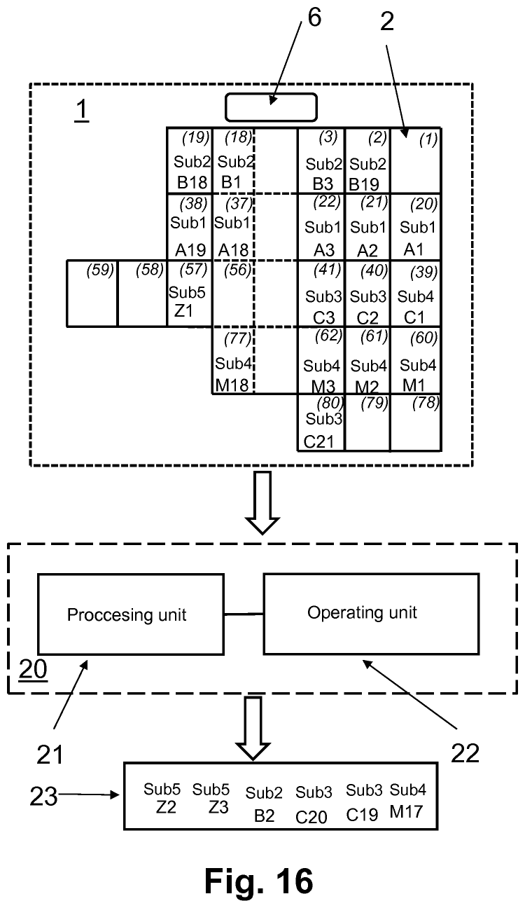

FIGS. 15 and 16 illustrate the state of before and after the production of the ingestible product. As shown in FIG. 16, the ingestible product 23 comprises the active substances stored in the storage elements 1, 56, 58, 59, 78, and 79. For presenting the function of the device, a storage assembly 1 comprising 80 storage elements are shown in the FIGS. 15 and 16. However, the number of the storage elements included in the storage assembly is not limited to 80. Depending on the application, the number of the storage elements contained in the storage assembly may be up to several thousands.

### LIST OF REFERENCES

1 storage assembly
2 storage element
2a cavity
2b globule
2c reservoir
2d microcapsule
3 active substance
4 substrate storage element
5 blister packaging
5a top sheet
5b bottom sheet
5c glued part
6 assembly property
7 container
7a nozzle
8 tubular container
8a closure
9 reservoirs as storage element
9a flap
9b discharging means
9c valve
10 assignment information
11 data element
12 element property
13 cap
20 production device
21 processing unit
22 operating unit
23 ingestible product
30a, 30b, 30c storage elements of the first group
30, 31, 31 first, second and third group

1. A storage assembly for storing active substances for producing an ingestible product, the storage assembly comprising: a plurality of storage elements, wherein the plurality of storage elements is grouped into two or more groups of storage elements, wherein for each group the storage elements of the respective group have stored the same type of an active substance, wherein at least one group includes at least two storage elements, wherein for each one of the storage elements of the plurality of storage elements has stored one or more portions of an active substance, the one or more portions containing the same amount of the active substance, defined as a dose bit, and wherein for at least one group the dose bits of the storage elements are defined in accordance a dose pattern, such that the respective type of active substance can be dosed over a given range and with a given precision for producing the ingestible product by using the one or more portions of the storage elements of the respective group, wherein the storage assembly is configured such that the ingestible product can be produced by using one portion from each storage element of a subset of storage elements and wherein the storage elements are designed such that the dose bit and/or type of the active substance stored in each of the storage elements is identified by an element property of the storage element and an assignment information of the storage assembly.

2. (canceled)

3. The storage assembly according to claim 1, wherein at least one group comprises more than 2 storage elements.

4. The storage assembly according to claim 1, wherein the storage assembly includes at least 8 groups of storage elements.

5. The storage assembly according to claim 1, wherein the dose bits of at least one group are defined in accordance with a dose pattern, which is based on at least one of: a binary system, a decimal system, an octal system, a hexadecimal system, a 1-2-5 system, a Fibonacci system, or any combination thereof.

6. (canceled)

7. (canceled)

8. The storage assembly according to claim 1, wherein at least one of the plurality of storage elements has one or more of the following forms: a cavity, a globule, a microcapsule, a pill, a reservoir or a coated carrier.

9. The storage assembly according to claim 1, wherein the storage elements are arranged in one or more of: a three-dimensional lattice, a two-dimensional array, a one-dimensional array, a chain along a line or wire, an array along a curve, a loose or rigid grouping in a container, or any combination thereof.

10. The storage assembly according to claim 1, wherein the element property is related to one or more of the storage element in the storage assembly, an externally readable code such as a pattern or color, an electromagnetic property of the storage element, any other physical property, any other chemical property, or any combination thereof.

11. (canceled)

12. The storage assembly according to claim 1, wherein the storage elements are designed such that the storage elements are selectively activated based on an activation property of the storage elements.

13. The storage assembly according to claim 12, further comprising: an assembly property which enables a retrieval of the assignment information of the storage assembly.

14. The storage assembly according to claim 13, wherein the assignment information is kept secret from the end user.

15. A plurality of storage assemblies according to claim 1, wherein each storage assembly has an individual assignment.

16. A production device for producing an ingestible product, the production device comprising a storage assembly according to claim 1 and a discharging means configured to discharge portions of the active substances from the storage elements, the production device configured to select the subset of the storage elements, discharge a portion of the active substances from each selected storage element, and combine the discharged active substances to form the ingestible product.

17. (canceled)

18. (canceled)

19. The production device according to claim 16, further configured to receive data defining the storage elements to be selected, and discharge the portions of the active substances from the selected storage elements.

20. (canceled)

21. The production device according to claim 16, wherein the production device is configured such that a bit pattern can be applied, each element of the bit pattern defining whether a portion of the active substance stored in the respective storage element is required for producing the ingestible product.

22. A method for producing an ingestible product using a storage assembly according to claim 1, the method comprising:
receiving data defining the storage elements to be selected;
discharging the portions of the active substances from the selected storage elements;
selecting a subset of the storage elements;
discharging from each selected storage element a portion of the active substance; and
combining the discharged active substances to form the ingestible product.

23. (canceled)

24. (canceled)

25. The storage assembly according to claim 1, wherein at least one group comprises more than 6 storage elements.

26. The storage assembly according to claim 1, wherein at least one group comprises more than 12 storage elements.

27. The storage assembly according to claim 1, wherein the storage assembly comprises at least 20 groups of storage elements.

28. The storage assembly according to claim 1, wherein the storage assembly comprises at least 100 groups of storage elements.

29. The storage assembly of claim 10, wherein the externally readable code comprises at least one of a pattern or a color.
